(19) United States
(12) Patent Application Publication
(10) Pub. No.: US 2011/0310708 A1
(43) Pub. Date: Dec. 22, 2011

(54) METHOD AND DEVICE FOR SETTING TIME

(75) Inventor: JIAN-PING CHEN, Shenzhen City (CN)

(73) Assignees: CHI MEI COMMUNICATION SYSTEMS, INC., Tu-Cheng City (TW); SHENZHEN FUTAIHONG PRECISION INDUSTRY CO., LTD., ShenZhen City (CN)

(21) Appl. No.: 12/831,277

(22) Filed: Jul. 7, 2010

(30) Foreign Application Priority Data
Jun. 17, 2010 (CN) 201010202044.4

(51) Int. Cl. G04C 11/00

(52) U.S. Cl. 368/46

(57) ABSTRACT

A device with a camera take pictures of a clock in order to use the time displayed on the clock to calibrate the time thereof. The device identifies elements related to time representation and extract features from the identified elements. The device translates the extracted features into a time data. The device sets time thereof with the time data.

### BACKGROUND

1. Technical Field

Embodiments of the present disclosure relate to user interface, and more particularly to a method and electronic device for setting time.

2. Description of Related Art

In order to correct a displayed time of a clock, such as putting forward or putting back the displayed time of the clock, one switch or two independent switches/buttons for time correcting speed can be changed from slow to fast. It is necessary to manipulate the one or two switch keys/buttons while monitoring the displayed time so as to set the clock to a desired time. A person who wishes to correct or change the time has to carefully manipulate a time correction key while looking at the display to determine whether or not the time displayed reaches the desired corrected or changed time.

### BRIEF DESCRIPTION OF THE DRAWINGS

FIG. 1 is a block diagram of one embodiment of an electronic device for setting time thereof.

FIG. 2 is a flowchart of one embodiment of a method for setting time of an electronic device.

FIG. 3 is one exemplary embodiment of a clock.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used herein, refers to logic embodied in hardware or firmware, or to a collection of software instructions, written in a programming language, such as, for example, Java, C, or assembly. One or more software instructions in the module may be embedded in firmware, such as an EPROM. It will be appreciated that module may comprise connected logic units, such as gates and flip-flops, and may comprise programmable units, such as programmable gate arrays or processors. The units described herein may be implemented either as software and/or hardware module and may be stored in any type of computer-readable medium or other computer storage device.

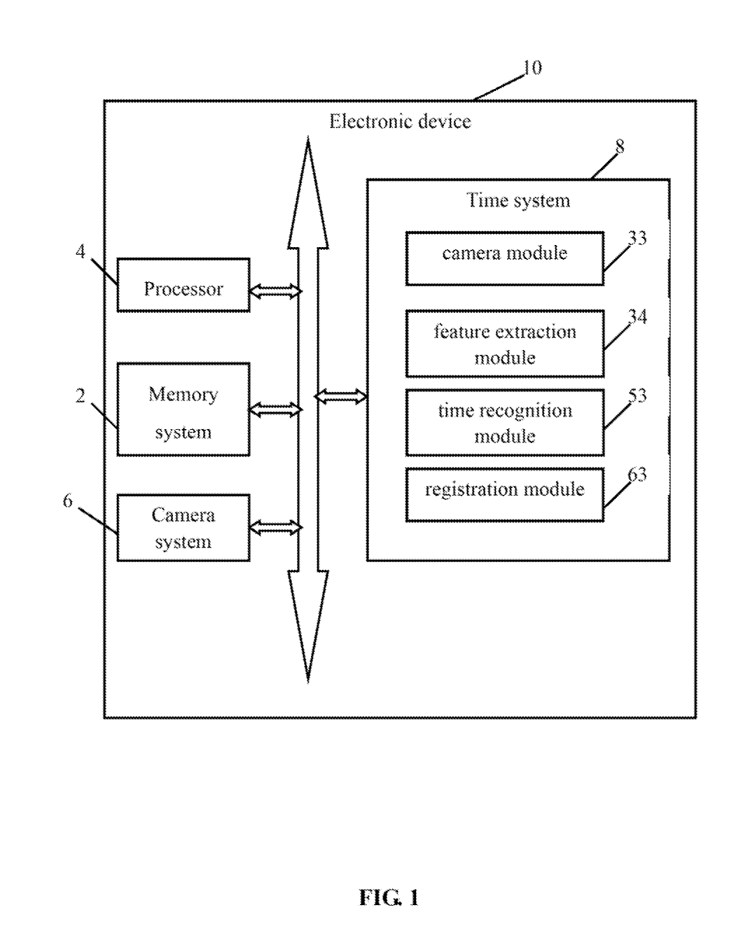

FIG. 1 is a block diagram of an electronic device 10 comprising a camera system 6 and a time system 8. The device 10 uses the camera system 6 to take pictures of a clock. The time system 8 reads a time from the pictures and calibrates system time of the device 10 with the read time. Depending on the embodiment, the electronic device 10 can be a mobile phone, or a notebook, for example.

The time system 8 includes a camera module 33 to control the camera system 6 of the electronic device 10 to take pictures of the clock, a feature extraction module 34 to extract features from the pictures, a time recognition module 53 to heuristically translate the features into a time data, and a registration module 63 to set time of the electronic device 10 with the time data. One or more computerized codes of the modules are stored in the memory system 2 and are executed by one or more processors 4.

The camera module 33 is operable to control the camera system 6 of the electronic device 10 to take pictures of the clock. The clock mentioned herein can be a quartz clock with hands or an electronic watch with a digital display. In one embodiment, the pictures may be saved in the memory system 2, in any of a number of non-destructive image or graphic formats, such as BMP, TIFF, PNG, or PCX.

The feature extraction module 34 is operable to identify elements related to time representation in the pictures and extract features from the identified elements. In the embodiment, the elements can be possible digital characters, the hands of the clock, and/or time representation symbols. For example, the time representation symbols may include abbreviations, such as “AM” or “PM”, indicative of relative information to noon. The time representation symbols may also include figures, such as the sun and the moon, indicative of daytime or nighttime. The time representation symbols may further include symbols, such as “:' or “/”, in aid of identification of the type of the clock.

The extracted features include areas and coordinates of relevant points of the extracted features. In the embodiment, the areas are defined as sets of borders around the identified elements. The relevant points are symmetric centers of the areas defined herein and all ends of the hands of the clock. The features are then transmitted to the time recognition modules 53.

The time recognition module 53 is operable to analyze the areas to interpret the identified elements as time-related information and calculate angles formed by heuristically connecting the relevant points. The time recognition module 53 includes a training set of numbers and the time representation symbols and adopts k-nearest neighbors algorithm (k-NN) to compare the training set with the extracted features. For example, the time recognition module 53 can recognize the possible digital characters as quantitative numbers. In the embodiment, the time recognition module 53 heuristically translates the features into a time data using the recognized possible digital characters and the calculated angles.

It should be understood that to read minutes of the clock in a human-like cognition way is equivalent in mathematics to divide the angle between the 12 o'clock direction and the minute hand direction by 6. For example, a reasonable heuristic to estimate the 12 o'clock direction can be to connect the symmetric center of the possible digital character “12” and the joint end of the minute hand and the hour hand. The same heuristic applies to finding the minute hand direction by connecting two ends of the minute hand. Another heuristic is to use a correlated direction of the possible digital characters as the estimated 12 o'clock direction. The time recognition module 53 transmits the translated time data to registration module 63.

The registration module 63 is operable to set time of the electronic device 10 with the time data. The registration module 63 also applies to any other time-dependent system services of the electronic device 10, such as an alarmed clock or a timer.

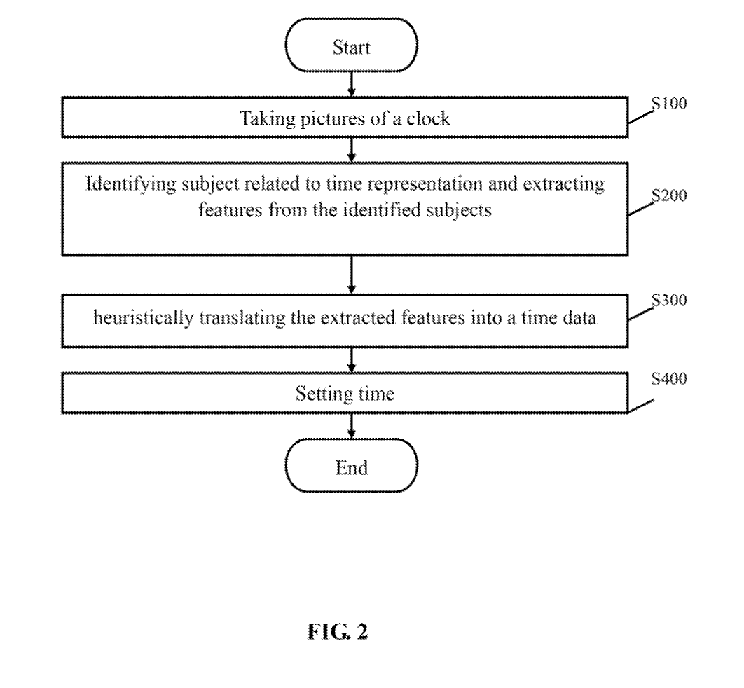

FIG. 2 is a flowchart of one embodiment of a method for setting time of the electronic device 10. Additional blocks may be added to the method, others removed, and the ordering of the blocks may be changed.

In block S100, the camera module 33 of the time system 8 controls the camera system 6 of the electronic device 10 to take the pictures of the clock. In block S200, the feature extraction module 34 identifies the elements related to time representation in the pictures and extracts the features from the identified elements. In block S300, The time recognition module 53 heuristically translates the features extracted from the pictures into the time data. In block S400, the registration module 63 sets the time with the time data.

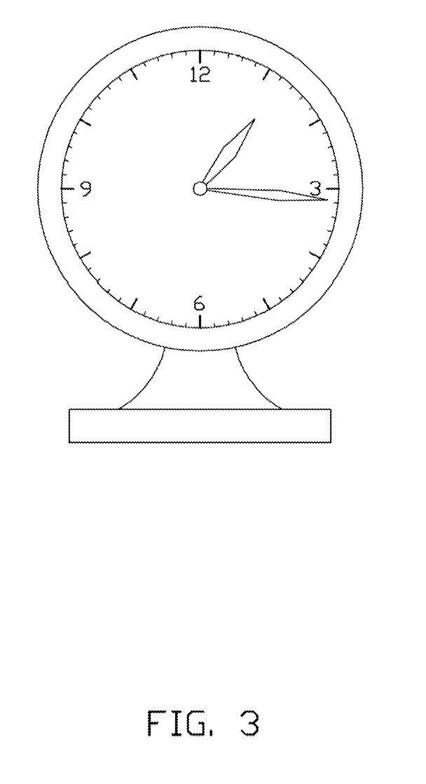

FIG. 3 is one example of the clock indicative of 01:16 AM/PM. In the example, the feature extraction module 34 identifies certain elements of the clock as being possible representations of digital characters and certain other elements as being hands (hour hand, minute hand) of the clock. In this example, since the clock comprises digital characters 3, 6, 9, 12, there are four possible digital characters. Furthermore, the feature extraction module 34 can identify the clock having two hands (an hour hand and a minute hand). Moreover, the feature extraction module 34 can extract additional features of the clock including areas of the four possible digital characters and the hands of the clock. The features further include the coordinates of all ends of the hands of the clock and of the symmetric centers of the areas of the 4 possible digital characters.

The time recognition module 53 processes the four possible digital characters with pattern recognition technology. The result comes back as numbers, 3, 6, 9, and 12. The time recognition module 53 heuristically determines the numbers, 3, 6, 9, and 12 to be time related because relative positions of the coordinates of the symmetric centers are highly correlated to a clock layout.

The time recognition module 53 calculates the angle from a minute hand to an hour hand counter-clockwise, say 55 degrees. It should be understood that the minute hand goes faster than the hour hand, 5.5 degrees per minute faster exactly. In other words, the 55 degrees angle means a 10 minutes passage since an overlap of the minute hand and the hour hand.

The overlap happens when the minute hand “catches up” with the hour hand. Take 1 o'clock for example, the hour hand is 30 degrees ahead of the minute hand. Since the minute hand goes 5.5 degrees faster than the hour hand. The minute hand will catch up with the hour hand in exact 30/5.5 minutes, approximate 6 minutes. In order to heuristically compute the catch-up time discrepancy, the time recognition module 53 deploys the distances between the coordinates of the free end of the hour hand to the coordinates of areas of all possible digital characters. The heuristic applies as following.

A distance between the free end of the hour hand and the symmetric center of the digit 12 is the minimum which suggests that the hour hand pointing in a direction of the digit 12 within a 90 degrees margin. A distance between the free end of the hour hand and the symmetric center of the digit 3 is the second minimum, which narrows down the 90 degrees margin to a 45 degrees margin. And also the second minimum minus the minimum is relatively small to the minimum, which confines the hour hand pointing roughly in a direction between 1 o'clock and 2 o'clock. The catch-up time discrepancy is thereby approximate 6 minutes.

Combining with the angle 55 degree, the time recognition module 53 calculate a corresponding time to be 01:16 or 13:16. The time recognition module 53 heuristically filters out unlikely results based on original time since no time representation symbols presented. The time recognition module 53 then transmits the time data to the registration module 63.

It is to be understood, however, that even though numerous characteristics and advantages of the disclosure have been set forth in the foregoing description, together with details of the structure and function of the present disclosure, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. An electronic device for setting time thereof, comprising:
a camera system;
a memory system;
one or more processors; and
one or more programs stored in the memory system and configured to be executed by the one or more processors, the one or more programs comprising:
a camera module to control the camera system to take pictures of a clock;
a feature extraction module to identify elements related to time representation in the pictures and extract features from the identified elements;
a time recognition module to heuristically translate the extracted features into a time data; and
a registration module to set time of the electronic device with the time data.

2. The electronic device as claimed in claim 1, wherein the identified elements of the pictures comprises possible digital characters, angles formed by hands of the clock, and time representation symbols.

3. The electronic device as claimed in claim 2, wherein the time representation symbols comprise abbreviations indicative of relative information to noon, figures indicative of daytime or nighttime, and symbols in aid of identification of the type of the clock

4. The electronic device as claimed in claim 1, wherein the extracted features comprise areas defined as sets of borders around the identified elements and coordinates of relevant points, wherein the relevant points include symmetric centers of the areas and all ends of the hands of the clock.

5. The electronic device as claimed in claim 4, wherein the time recognition module analyzes the areas to interpret the identified elements as time-related information and calculates angles formed by connecting the relevant points.

6. The electronic device as claimed in claim 1, wherein the registration module applies to other time-dependent system services of the electronic device.

7. A method for setting time of an electronic device, comprising:
operating a camera system of the electronic device to take pictures of a clock;
identifying elements related to time representation in the pictures;
extracting features from the identified elements;
heuristically translating the extracted features into a time data; and
setting time of the electronic device with the time data.

8. The computer-implemented method as claimed in claim 7, wherein the identified elements comprises possible digital characters, angles formed by hands of the clock, and time representation symbols.

9. The computer-implemented method as claimed in claim 8, wherein the time representation symbols comprise abbreviations indicative of relative information to noon, figures indicative of daytime or nighttime, and symbols in aid of identification of the type of the clock.

10. The computer-implemented method as claimed in claim 7, wherein the extracted features comprise areas defined as sets of borders around the identified elements and coordinates of relevant points, wherein the relevant points include symmetric centers of the areas and all ends of the hands of the clock.

11. The computer-implemented method as claimed in claim 10, wherein the electronic device comprises a time recognition module to analyze the areas to interpret the identified elements as time-related information and to calculate angles formed by connecting the relevant points.

12. The computer-implemented method as claimed in claim 7, wherein the step of setting time of the electronic device applies to other time-dependent system services of the electronic device.

13. A computer readable storage medium having stored therein instructions, that when executed by an electronic device, cause the device to:
use a camera system of the electronic device to take pictures of a clock;
identify elements related to time representation in the pictures;
extract features from the identified elements;
heuristically translate the extracted features into a time data; and
set time of the electronic device with the time data.

14. The computer readable storage medium as claimed in claim 13, wherein the identified elements comprises possible digital characters, angles formed by hands of the clock, and time representation symbols.

15. The computer readable storage medium as claimed in claim 14, wherein the time representation symbols comprise abbreviations indicative of relative information to noon, figures indicative of daytime or nighttime, and symbols in aid of identification of the clock's type

16. The computer readable storage medium as claimed in claim 13, wherein the extracted features comprises areas defined as sets of borders around the identified elements and coordinates of relevant points, wherein the relevant points include symmetric centers of the areas and all ends of the hands of the clock.

17. The computer readable storage medium as claimed in claim 16, wherein the electronic device comprises a time recognition module to analyze the areas to interpret the identified elements as time-related information and to calculate angles formed by connecting the relevant points.

18. The computer readable storage medium as claimed in claim 13, wherein the operation of setting time of the electronic device applies to other time-dependent system services of the electronic device.
